(19) United States
(12) Patent Application Publication
(10) Pub. No.: US 2012/0128403 A1
(43) Pub. Date: May 24, 2012

(54) PIN-SHAPED DEVICE FOR APPLYING A LIQUID

(75) Inventors: Volker Koelsche, Schalksmuehle (DE); Frank Roemer, Finnentrop (DE); Ramon Pradas Cortina, Corbera de Llobregat (Barcelona) (ES); Lorenzo Crespo Catalan, Molins de Rei (Barcelona) (ES)

(73) Assignee: GEORG MENSHEN GmbH & Co. KG, Finnentrop (DE)

(21) Appl. No.: 13/321,541

(22) PCT Filed: Mar. 24, 2010
(86) PCT No.: PCT/EP2010/001831

§ 371 Date: Feb. 6, 2012

(30) Foreign Application Priority Data
May 18, 2009 (DE) 10 2009 021 816.5
Oct. 30, 2009 (EP) 09013671.4

(51) Int. Cl. B43K 5/00

(52) U.S. Cl. 401/206

(57) ABSTRACT

The invention relates to a pin-shaped device for applying a liquid to a surface, having a tank (8) receiving the liquid and an application head (1) connected to the tank, on the exterior of which on the side facing away from the tank a liquid-permeable application body is mounted coaxially, to which liquid is fed from the tank, wherein the outer diameter (1) of the tank (8) is 1/3 to 2/3 of the outer diameter of the application head (1), and the tank (8) protrudes outward coaxially to the application head (1).

The invention relates to a pin-shaped device for applying a liquid to a surface, with a liquid-receiving container or tank and an application head coupled to the container, there being coaxially secured, to the exterior of the head, on the container-remote side, a liquid-permeable application body, to which liquid from the container is fed.

Application devices in the form of a tube are known, for containing a leather-treating liquid which, via a sponge application head, dispense the liquid onto the surface of a shoe. The container or tank of these known application devices has a relatively large volume, and therefore has relatively large outer dimensions, facilitating gripping the device in the hand. However, for smaller amounts of liquid, especially in the medical or cosmetic fields, such a device is not usable.

It is an object of the invention to improve a device of the aforementioned type so that, in the case of small content volumes of liquid, the device is easily and securely grippable. A further object of the invention is, while keeping the construction and assembly simple, to increase functional reliability and precision of administration or manipulation.

These objects are achieved, in accordance with the invention, by forming the outer diameter of the tank ⅓ to ⅔ the outer diameter of the application head, and having the tank protrude outward, uncovered, coaxial with the application head. Alternatively, these objects are achieved, in that the outer diameter of the contain is about ⅓ to ⅔ the outer diameter of the application head, and in that the container is externally surrounded, coaxially, by a bell-shaped cover cap, whose outer diameter is the same as, or insignificantly smaller than, the outer diameter of the application head, so that between the container and the cap, an empty annular space is defined.

Despite a small content capacity and therefore a small container for the application fluid or liquid, the application-head-remote and application-body-remote portion of the pin-shaped device can be easily and reliably gripped. Therefore, the device can hold small quantities of an effective substance, and nevertheless be easily manipulable.

The form of the container is independent of the form of the cover cap and can thus be variable, and simple and inexpensive to manufacture. However, since the external form of the cover cap can be independent of the form of the container, the exterior of the cover cap can be varied at will. The external form of the cover cap can be chosen to match the type of application fluid, so that one can recognize from the exterior, which application fluid the device dispenses. For example, the level of concentration of the effective substance can be recognized from the form and/or the color of the cover cap.

Advantageously, it is proposed that the fluid is disinfecting, for application to the skin of a person or an animal. It is further proposed that the container extends, within the cap, across the greater part of the cap interior.

Since the form of the cap does not need to be determined by the size and form of the container, the cap can have a round, an oval, a triangular, or a rectangular cross-section with rounded-off longitudinal corners and, particularly, with convex sides.

A particularly advantageous outer configuration of the cap is provided, if the cap tapers down as distance from the application head increases. This way, the cover cap is not only attractive, but also easy to grip with the hand. For this purpose, it is also suggested that the cap have exterior gripping indentations. It is particularly advantageous if the hollow space between the container and the cover cap is sufficiently sealed off, that a pressure from the hand on the exterior of the cover cap increases the pressure in the container, and regulates the discharge or dispensing.

Advantageously, it is proposed that the application head comprise a sponge, a non-woven fabric, or a brush.

In order to assure, during transport and storage, that the container interior does not come into contact with the atmosphere, and is opened for the first time upon first use of the container, it is proposed that the application head have two mutually rotatable coaxial disk elements, each forming a transit channel for the fluid, the transit channel of the first disk element being closed by a closure, especially a membrane, and that the second disk element has an opening element, especially a cutter, by which the closure, especially the membrane, can be opened. Preferably, the two disk elements are coupled to each other by a thread and counterthread, so that, upon rotation of the disk elements with respect to each other, they come closer together. Such a structure can be made small, and does not unnecessarily increase the length of the pin-shaped device.

For this purpose, it is proposed that the first disk element form the top side of the container. Further, it is advantageous if, after the rotation and opening of the closure, especially the membrane, the two disk elements are irreversibly engaged together. Thereby, it is assured that, after the first-time opening, the transit channel is not inadvertently closed again.

The actuation of the first-time opening is facilitated, if the rotatable disk element has a grippable ring-shaped exterior. It is further proposed that, on the outside of the rotatable disk element, the permissible direction of rotation for opening is indicated, so that the user can easily recognize the type of manipulation intended.

In order to assure that, in the course of application of the fluid, an excessive quantity does not come out of the device, it is proposed that, inside the application head, in the transit channel, a metering value is arranged as a surge brake. The metering value can be formed with a coaxial insertable element having a metering part, which partially closes the transit channel and creates a resistance to the fluid flow or stream. It is also advantageous if the metering element is movable in a single direction by an increasing fluid flow, the metering valve becoming thereby further opened.

A particularly exact application of fluid is possible if the application head has, in a cross-section perpendicular to the device longitudinal axis, a triangular form with rounded-off corners and, in particular, has convex sides.

Advantageous embodiments of the invention are shown in the drawings and are described below in greater detail. Shown are:

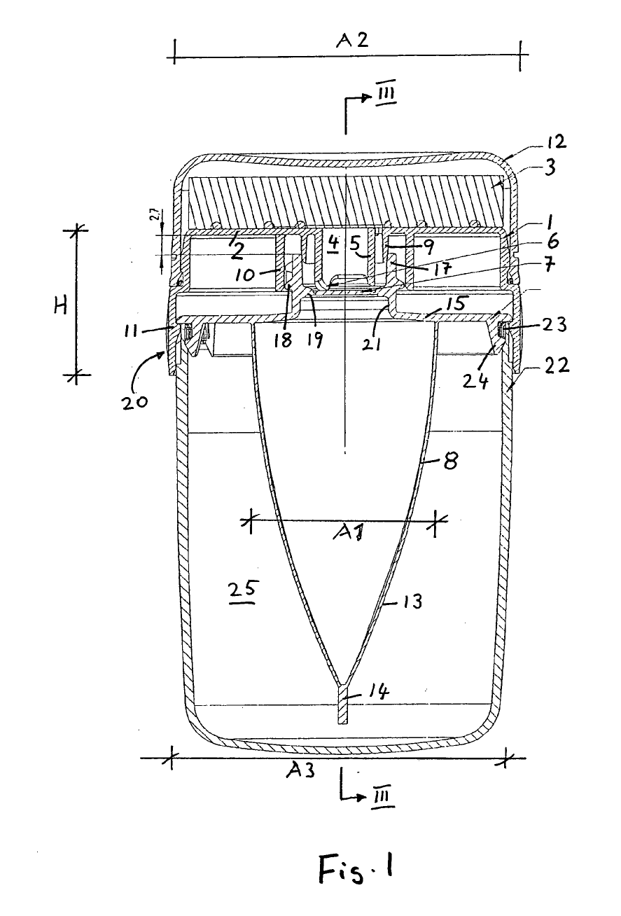

FIG. 1 is an axial section through the device, with a still-closed container;

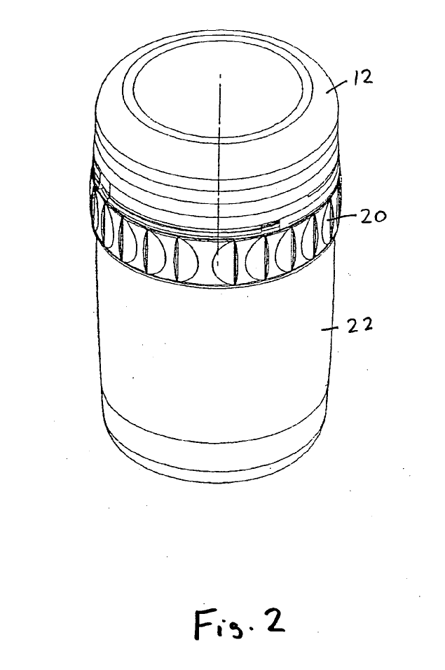

FIG. 2 is a side view of the device according to FIG. 1;

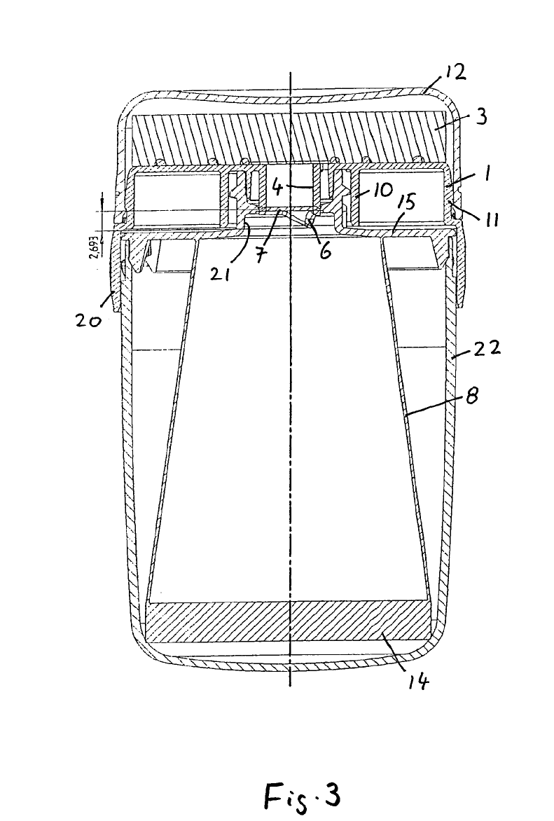

FIG. 3 is an axial section along lines III-III of FIG. 1 with an opened container;

FIG. 4 is an axial section through the upper portion of the application head of a second embodiment, having an inserted valve as surge brake;

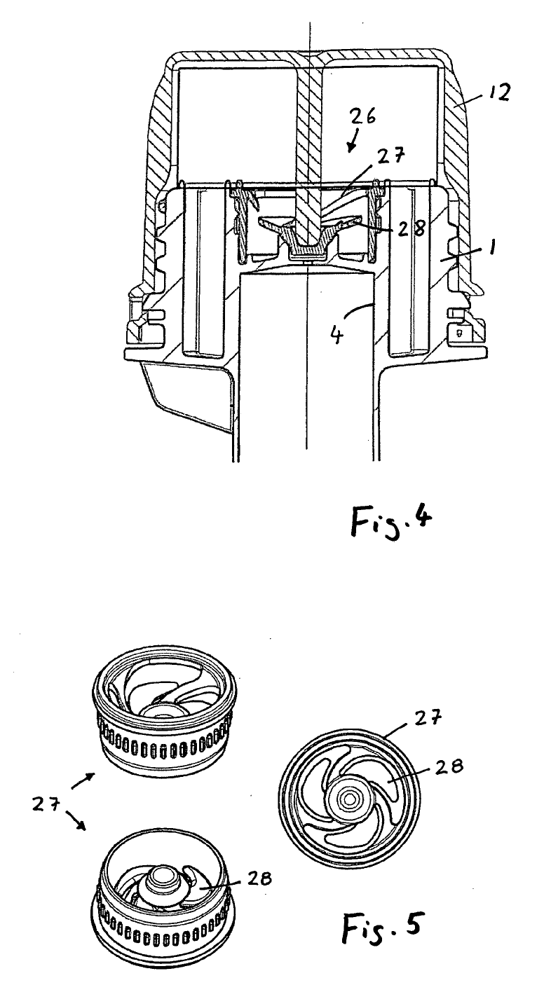

FIG. 5 shows the inserted valve in three views;

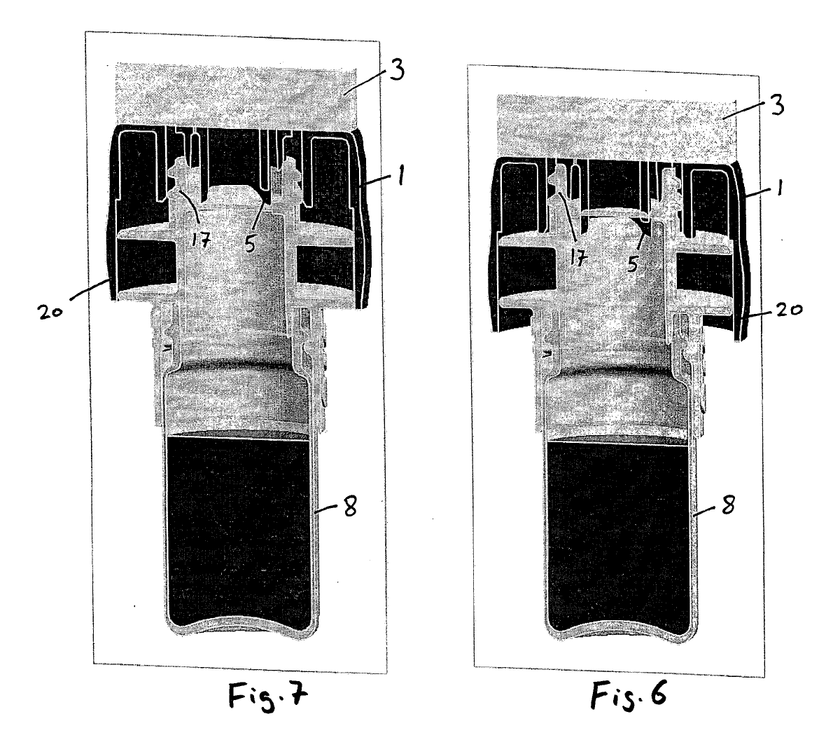

FIG. 6 shows a third embodiment, without cover cap, with a closed container; and

FIG. 7 shows the third embodiment with an open container.

The pin-shaped application device for fluids has an application head 1, which is pot-shaped, with a circular planar disk part 2 at whose front side an application body 3 is secured, and bridges over to a central coaxial transit channel 4 in application head 1. The disk-shaped circular application body 3 has a uniform thickness D and consists of an open-pore sponge, a non-woven fabric, or a brush, in order to distribute across its width, the fluid issuing from channel 4 and to dispense it, whenever the application body presses, with its front side, onto a surface, and is swiped across the surface. On the rear side of the disk-shaped part 2 of the application head 1, a coaxial tubular support 5 is formed, defining the transit channel 4. At its free end, support 5 forms cutting elements 6, in order, upon rotation relative to a container 8, to enable cutting of a membrane 7 of the container.

Further, on the rear side of disk-shaped part 2, a coaxial sealing ring 9 and a bushing or sleeve 10 are provided, the diameter of the sealing ring 9 being greater than that of support 5, and the diameter of bushing 10 being greater than that of the sealing ring. Further, on the outer rim of disk-shaped part 2, a coaxial cylindrical wall or skirt 11 is formed, whose height H is about twice as large as the height of bushing 10 and of support 5.

On the front side of the device, the application body 3 is covered by a protective cap 12, which partly grips over wall 11 and forms a protected space, within which the application body is located. Container 8 has an originally cylindrical outer wall whose lower rim is pressed together into a straight band or ligature 14, and is thereby closed off. At its upper end, adjacent application head 1, container or tank 8 is closed off by a circular closure wall 15 which is disk-shaped, rests with its circular outer rim coaxially within application head 1 and is secured on the inner side of wall 11 thereof.

Wall 15 is formed with a coaxial support 17 pointing toward application body 3, support 17 having a radially outwardly extending annular ring region 18 which rests sealingly within bushing 10. Support 17 is closed off by a membrane 7, formed with a circular coaxial thin point or frangible point 19. The annular end of support 17 which is adjacent to application body 3 rests in sealing engagement against the outer surface of sealing ring 9.

Wall 11 of application head 1 forms, on its exterior, a grip ring 20, manipulable by the hand, and rotatable relative to tank 8 and its wall 15. For this purpose, the outer rim of wall 15 moves along an internal thread of wall 11, so that, due to the rotation movement of grip ring 20 and of wall 11 relative to tank 8 and its wall 15, the application head 1 moves axially relative to wall 15, and causes cutting element 6 to press against membrane 7, in order to open the membrane, and thereby the support 17. After the opening, support 17 remains in sealing engagement against sealing ring 9, so that transit channel 4 is sealingly connected with transit channel 20 of support 17, and liquid from tank 8 can flow into application body 3, without being able to leak out sideways.

Application head 1 has coaxially mounted, on its side remote from application body 3, a cover cap 22 having an inner upper rim 23 secured on the inside of wall 11. The upper rim 23 engages between wall 11 and an annular lip 24 projecting on the outer side of wall 15. Cover cap 22 is arranged non-rotatable with respect to wall 11 and tank 8, but rotatable with respect to wall 11 of application head 1, so that, by means of another grasp of cover cap 22, tank 8 can be held stationary, while application head 1 is rotated via the grip ring 20.

Cover cap 22 surrounds tank 8 in such a spaced manner that, between tank and cover cap, a hollow space 25 arises, which is so sealed from ambient air that a pressure on the outside of the cover cap elevates the pressure within tank 8. The outer diameter A1 of tank 8 has about ⅓ to ⅔ the outer diameter A2 of the application head or of the cover cap, assuming that the application head and the cover cap have about the same outer diameter. Tank 8 extends, within cover cap 22, over the greater part of its length, and cover cap 22 can have a round, oval, triangular or rectangular cross-section, with rounded-off longitudinal corners and, especially, can have convex sides.

Cover cap 22 can have a variety of forms and, in one embodiment, the cap narrows down with increasing distance from the application head. In order for cover cap 22 to be particularly easy to grip, it has, in one embodiment, external gripping grooves or indentations. In a similar manner, grip ring 20 can also have external indentations or rifling or ridged regions. In order that the user knows, in which direction grip ring 20 should turn, an arrow is placed on the exterior, indicating the rotation direction.

In the embodiment illustrated in FIGS. 4 and 5, within the application head, in transit channel 4, a metering valve 26 is provided, having a coaxial inserted part 27, which partially closes transit channel 4, in order to present a resistance to liquid flow, thus serving as a brake on surges. For this purpose, the metering part can be movable in response to increasing liquid flow, thereby making the metering valve further open.

The inserted part 27 has a wing-shaped portion 28, which forms the resistance to the liquid flow, and has limited bendability, in order to achieve a further opening of the metering valve.

The application body 3 can have, instead of a circular form, a different form, especially a triangular or arrow-shaped form, in order to enable the application medium, which is preferably disinfecting, to be applied particularly exactly onto the skin of a human or an animal.

The third embodiment, shown in FIGS. 6 and 7, differs from the previously described embodiments, in that the tank 8 is not covered by a cover cap, and is thus freely visible. Further, in all embodiments, the protective cap 12 can be omitted.

1. A pin-shaped device for applying a liquid onto a surface, comprising
a liquid-receiving tank (8);
an application head (1) coupled to the tank (8);
a liquid-permeable application body (3) coaxially fastened to said application head, to which head liquid from the tank is fed, wherein
the outer diameter (A1) of the tank (8) is ⅓ to ⅔ the outer diameter (A2) of the application head (1) and
the tank (8) projects outward, uncovered, coaxial to the application head (1).

2. A pin-shaped device for applying a liquid to a surface, comprising
a liquid-receiving tank (8);
an application head (1) coupled thereto, having coaxially mounted, on its exterior tank-remote side, a liquid-permeable application body (3) to which liquid from the tank is fed, wherein
an outer diameter (A1) of the tank (8) is ⅓ to ⅔ the outer diameter (A2) of the application head (1);
the tank (8) is coaxially surrounded by a pot-shaped cover cap (22) having an outer diameter (A3) which is no larger than, the outer diameter (A2) of the application head (1); and
between the tank (8) and the cap (22) an annular hollow space (25) is formed.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. The device of claim 1,
further comprising
a disinfecting liquid in said tank (8) for application to the skin of a human or of an animal.

21. The device of claim 2,
further comprising
a disinfecting liquid in said tank (8) for application to the skin of a human or of an animal.

22. The device of claim 2,
wherein
the tank (8) extends within the cap (22) over a majority of a length of the interior space within said cap.

23. The device according to claim 2,
wherein
the cap (22) has rounded-off longitudinal corners and sides formed with gripping surfaces.

24. The device according to one of claim 2,
wherein
the cap (22) has a diameter which tapers down as distance from the application head (1) increases.

25. The device according to claim 2,
wherein
the hollow space (25) between tank (8) and cover cap (22) is so sealed that pressure of a hand on the outside of the cover cap elevates pressure in the tank and thereby controls dispensing from it.

26. The device according to claim 1,
wherein
the application head (1) has two coaxial disk parts (2, 15), rotatable with respect to each other, each having a transit channel (4, 21) for the liquid;
the transit channel (21) of the first disk part (15) being closed by a closure (7);
the second disk part (2) having an opening element, particularly a cutter (6), by means of which the closure can be opened, and
the two disk parts are coupled to each other using a thread and counterthread, through which relative rotation of the disk parts (2, 15) brings them closer to each other.

27. The device of claim 26, wherein
the first disk part forms an upper side of the tank.

28. The device of claim 26,
characterized in that
subsequent to the rotation and the opening of the closure, particularly of the membrane (7), the two disk parts (2, 15) are irreversibly engaged with each other.

29. The device of claim 26,
wherein the rotatable disk part (2) has a grippable ring-shaped outside (20).

30. The device of claim 29,
wherein
on the outside (20) of the rotatable disk part (2), a permissible direction of rotation, for opening of the closure, is indicated.

31. The device claim 1,
wherein
within the application head (1), in the transit channel (4), a metering valve (2, 6) is provided as a surge brake.

32. The device of claim 31,
wherein
the metering valve (26) comprises a coaxial insert part (27) which as metering part partially closes the transit channel and which provides a resistance against liquid flow.

33. The device of claim 32,
wherein
the metering part (27) is movable due to increasing liquid flow in one direction, and thereby further opens the metering valve.

34. The device of claim 1,
wherein
the application body (3) has, in a section perpendicular to the device longitudinal axis, has a triangular form with rounded-off corners and especially, convex sides.

35. The device of claim 1,
wherein
between the application head (1) and a tank portion (15) facing toward the application body (3),
a thread is formed, by which the tank (8) is axially movable toward the application head (1), in order to open the tank.
